(19) United States
(12) Patent Application Publication
(10) Pub. No.: US 2024/0329934 A1
(43) Pub. Date: Oct. 3, 2024

(54) HARDWARE FRIENDLY RANDOMIZATION

(71) Applicant: Allegro MicroSystems, LLC, Manchester, NH (US)

(72) Inventors: Ahmed Hassan Fahmy, Andover, MA (US); Leandro Fuentes, Caba (AR); Khalid Chishti, Pepperell, MA (US)

(73) Assignee: Allegro MicroSystems, LLC, Manchester, NH (US)

(21) Appl. No.: 18/194,877

(22) Filed: Apr. 3, 2023

(51) Int. Cl. G06F 7/58; G06F 1/04

(52) U.S. Cl. CPC G06F 7/58; G06F 1/04

(57) ABSTRACT

A system comprising: a clock configured to generate a clock signal, the clock signal being arranged to have N type-1 features in a given time period, each of the N type-1 features of the clock signal being generated in a different one of a plurality of time slots of the given time period; a signal generator configured to generate a randomized signal based on the clock signal, the randomized signal being generated by selecting M time slots from the plurality of time slots and transitioning the randomized signal from a first value to a second value in each of the selected M time slots, wherein M and N are positive integers and M<N.

### BACKGROUND

A system may include a main oscillator, a clock divider, an analog-to-digital (ADC) converter, and other components. The clock divider may receive a clock signal from a main oscillator and divide the clock signal by a certain factor. This division is performed because the ADC convergence takes many clock cycles (especially in the case of sigma-delta ADC) while the DSP is assumed to take much less number of cycles to perform all the processing needed on a single ADC sample.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

According to aspects of the disclosure, a system is provided comprising: a clock configured to generate a clock signal, the clock signal being arranged to have N type-1 features in a given time period, each of the N type-1 features of the clock signal being generated in a different one of a plurality of time slots of the given time period; a signal generator configured to generate a randomized signal based on the clock signal, the randomized signal being generated by selecting M time slots from the plurality of time slots and transitioning the randomized signal from a first value to a second value in each of the selected M time slots, wherein M and N are positive integers and M<N, and wherein selecting the M time slots includes evaluating a respective randomized condition for each of the plurality of time slots and selecting the time slot when the randomized condition holds true, the randomized condition being based on a comparison between a count of remaining ones of the plurality of time slots for which the randomized condition has not been evaluated yet and a count of time slots that remain to be selected.

According to aspects of the disclosure, a method is provided, comprising: generating a clock signal, the clock signal being arranged to have N type-1 features in a given time period, each of the N type-1 features of the clock signal being generated in a different one of a plurality of time slots of the given time period; generating a randomized signal based on the clock signal, the randomized signal being generated by selecting M time slots from the plurality of time slots and transitioning the divided randomized signal from a first value to a second value in each of the selected M time slots, wherein M and N are positive integers and M<N, and wherein selecting the M time slots includes evaluating a respective randomized condition for each of the plurality of time slots and selecting the time slot when the randomized condition holds true, the randomized condition being based on a comparison between a count of remaining ones of the plurality of time slots for which the randomized condition has not been evaluated yet and a count of time slots that remain to be selected.

According to aspects of the disclosure, an enable signal generator, comprising: a selection circuitry configured to: (i) receive a clock signal that is arranged to have N type-1 features in a given time period, each of the N type-1 features of the clock signal being generated in a different one of a plurality of time slots of the given time period, and (ii) generate a selection vector based on the clock signal, the selection vector being arranged to identify M time slots that are selected from the plurality of time slots, where M and N are positive integers and 1≤M<N; and a signal generator configured to: (i) receive the selection vector from the selection circuitry and (ii) generate a randomized enable signal based on the selection vector, the randomized enable signal being generated by transitioning the randomized enable signal from a first value to a second value in each of the selected M time slots that are identified in the selection vector, wherein the M time slots are selected at random.

According to aspects of the disclosure, a method is provided, comprising: receiving a clock signal that is arranged to have N type-1 features in a given time period, each of the N type-1 features of the clock signal being generated in a different one of a plurality of time slots of the given time period; generating a selection vector based on the clock signal, the selection vector being arranged to identify M time slots that are selected from the plurality of time slots, where M and N are positive integers and 1≤M<N; and generating a randomized enable signal based on the selection vector, the randomized enable signal being generated by setting the randomized enable signal to a second value in each of the selected M time slots that are identified in the selection vector, wherein the M time slots are selected at random.

According to aspects of the disclosure, a system is provided, comprising: means for generating a clock signal, the clock signal being arranged to have N type-1 features in a given time period, each of the N type-1 features of the clock signal being generated in a different one of a plurality of time slots of the given time period; means for generating a randomized signal based on the clock signal, the randomized signal being generated by selecting M time slots from the plurality of time slots and setting the randomized signal to a second (active) value in each of the selected M time slots, wherein M and N are positive integers and M<N, wherein each of the plurality of time slots is equally likely to be selected.

### BRIEF DESCRIPTION OF THE DRAWING FIGURES

Other aspects, features, and advantages of the claimed invention will become more fully apparent from the following detailed description, the appended claims, and the accompanying drawings in which like reference numerals identify similar or identical elements. Reference numerals that are introduced in the specification in association with a drawing figure may be repeated in one or more subsequent figures without additional description in the specification in order to provide context for other features.

FIG. 1 is a diagram of an example of an electronic device, according to the prior art;

FIG. 2 is a diagram of an example of an electronic device, according to the prior art;

FIG. 3 is a diagram of an example of an electronic device that includes a random pipeline control circuit, according to aspects of the disclosure;

FIG. 4 shows a signal plot of a clock signal, a deterministic enable signal, and a randomized enable signal, according to aspects of the disclosure;

FIG. 5 shows a signal plot of a clock signal, a deterministic enable signal, and a randomized enable signal, according to aspects of the disclosure;

FIG. 6 shows a plot illustrating electromagnetic emissions of the devices of FIGS. 1-3, according to aspects of the disclosure;

FIG. 7 is a chart showing aspects of a clock signal, a deterministic enable signal, and a randomized enable signal, according to aspects of the disclosure;

FIG. 8 shows an example of an algorithm, according to aspects of the disclosure;

FIG. 9 is a diagram of an example of a random pipeline control circuit, according to aspects of the disclosure;

FIG. 10 is a diagram of an example of a clock divider, according to aspects of the disclosure;

FIG. 11 is a diagram of an example of a selection vector generator, according to aspects of the disclosure; and

FIG. 12 is a diagram of an example of an electronic device, according to aspects of the disclosure.

### DETAILED DESCRIPTION

Among many requirements that integrated circuits need to meet, electromagnetic compatibility (EMC) specifications are hard to meet for reasons having to do with the difficulty in predicting performance by simulation, lack of device models for the appropriate frequency range, and lack of understanding of the consequences of design decisions upon EMC results. Having design strategies to improve performance under this test is desirable and in need.

Some EMC specifications are related to the power consumption of an integrated circuit or in a container module. These specifications deal with the frequency content generated mostly, but not only, through the supply pins of the integrated circuit. An example of one such implementation is CISPR 25. CISPR 25 is an international standard that contains limits and procedures for the measurement of radio disturbances in the frequency range of 150 kHz to 925 kHz. The limits are intended to provide protection for receivers installed in vehicles from disturbances produced by components/modules in the same vehicle.

According to the present disclosure, an improved enable signal generator is provided that can reduce the emissions produced by an integrated circuit (or another system) that is driven with the clock divider. The enable signal generator randomly selects M time slots out of N. The randomly selected time slots are chosen to activate some digital functions of the circuit or system that is driven with the clock divider. This allows the spectrum of the current consumed by these digital circuits to be spread over large bandwidth with no undesired tones that adversely impact EMC/EMI performance.

In some implementations, the enable signal generator may depend on the value of a randomly-generated number with a varying constraint. This varying constraint may ensure that the exact number of desired slots are picked each time. Using the varying constraint ensures all slots have an equal probability of being selected, and thus a better suppression of undesired tones in the spectrum of the output current.

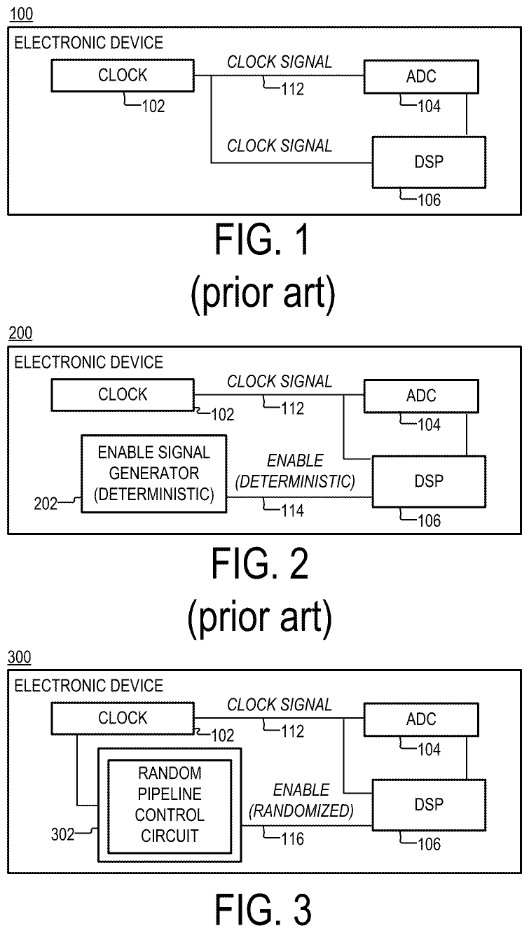

FIG. 1 is a diagram of an example of an electronic device 100, according to the prior art. As illustrated, device 100 may include a clock 102 (e.g., an oscillator) that is configured to generate a clock signal 112. The clock signal 112 may be arranged to drive an analog-to-digital converter (ADC) 104 and a Digital Signal Processor (DSP) 106.

FIG. 2 is a diagram of an example of an electronic device, 200, according to the prior art. Similar to device 100, device 200 may also include the clock 102, the ADC 104, and the DSP 106. Unlike device 100, device 200 may include a deterministic enable signal generator 202. The deterministic clock divider 202 may be arranged to produce a deterministic enable signal 114. Together with the clock signal 112, the deterministic enable signal 114 may be used to operate the DSP 106.

FIG. 3 is a diagram of an example of an electronic device 300, according to aspects of the disclosure. Similar to the devices 100 and 200, device 300 may also include the clock 102, the ADC 104, and the DSP 106. Unlike the devices 100 and 200, device 300 may include a random pipeline control circuit 302. The circuit 302 may be configured to receive the clock signal 112 and divide the clock signal to produce a randomized enable signal 116. Together with the clock signal 112, the randomized enable signal 116 may be arranged to operate the DSP 106. According to the present example, when the randomized enable signal 116 is logic high, the DSP 106 is active, whereas the DSP 106 is disabled when the randomized enable signal 116 is logic low. However, the present disclose is not limited thereto. Although in the present example, the randomized enable signal 116 is used to drive a DSP, alternative implementations are possible in which the randomized enable signal 116 is configured to drive one or more other electronic components, in addition to or instead of the DSP 106. Such electronic components may include one or more of an ADC, a digital-to-analog circuit (DAC), memory registers, a communications interface, another type of processing circuitry (e.g., a controller, a microprocessor, etc.). Although in the example of FIG. 3, the electronic device 300 is provided with a single random pipeline control circuit, alternative implementations are possible in which the electronic device 300 is provided with multiple random pipeline control circuits. In such implementations, each of the random pipeline control circuits may be configured to drive a different electronic component of the electronic device 300. As used herein, the term “randomized enable signal” shall refer to any signal that controls the operation of an electronic component, such that when the signal has a first value (e.g., logic high), the electronic component is turned “on” or active and when the signal has a second value (e.g., logic low), the electronic component is turned off or inactive. A randomized enable signal may be applied at a clock input of an electronic component, an enable port of the electronic component, and/or any other port of the electronic component. When the randomized enable signal is applied at the enable port of an electronic component, as is the case with DSP 106 in FIG. 3, the randomized enable signal may be used to step down the frequency of a clock signal that is used concurrently with the enable signal to drive the electronic component.

In some implementations, the DSP 106 may take much fewer clock cycles to process each sample from the ADC 104 than it takes the ADC 104 to generate this sample. Thus, in a period of N time slots, the circuit 302 may generate the signal 116 by selecting M slots that are needed for processing, where M and N are positive integers, and M<N. Moreover, N may be the time slots needed by ADC 104 to produce one new sample, and M may be the time slots needed by the DSP 106 to process the sample.

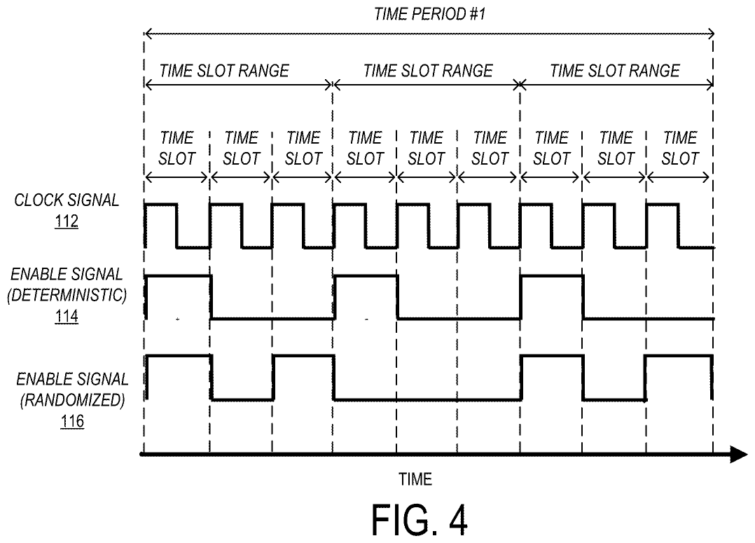

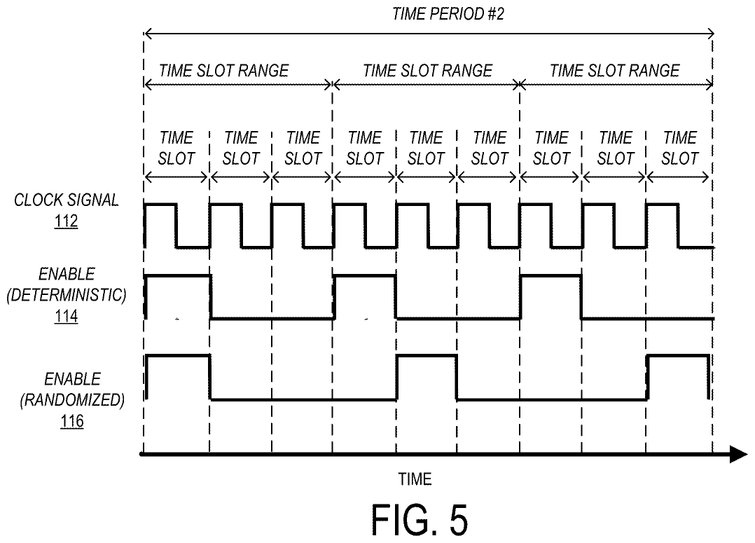

FIGS. 4-5 shows plots illustrating with greater clarity the difference between the signals 114 and 116. Shown in FIG. 4 are the values of the clock signal 112, as well as the signals 114 and 116, during a first time period. As illustrated, the time period may be divided into slot ranges. And each slot range may be divided into a plurality of time slots. As used herein, the terms “time period”, “time slot range”, and “time slot”, may refer to time periods of different duration which define the operation of an electronic device as it progresses in time. According to the present example, a time period has a greater duration than a time slot range, and a time slot range has a greater duration than a time slot. In some implementations, all time slots in a time period may have the same duration. Additionally or alternatively, in some implementations, all time slot ranges in a time period may have the same duration. In some implementations, each of the time periods in the operation of the device may divide evenly into time slot ranges, and each time slot range may divide evenly into time slots. Although in the example of FIGS. 4-5 a time period includes multiple time slot ranges, alternative implementations a time period may include a single time slot range. In this regard, the distinction between “time periods” and “time slot ranges” is introduced for the purposes of description only, and the terms “time slot range” and “time period” may be used interchangeably if this is permitted by context. Furthermore, it will be understood that a time slot range may include any number of time slots greater than or equal to two.

FIG. 4 illustrates that in a first time period, the clock signal 112 may alternate between logic-high and logic-low in each of the time slots. FIG. 4 further illustrates that the deterministic enable signal 114 may alternate between a logic-high and logic-low value every fourth time slot, while the randomized enable signal 116 alternates between logic-high and logic-low in a random pattern. In other words, the signal 114 exhibits a monotonous (i.e., single-frequency) switching pattern, whereas the signal 116 exhibits a switching pattern that is random and more spread over frequency.

FIG. 5 illustrates that in a second time period, the clock signal 112 may alternate between logic-high and logic-low in each of the time slots. FIG. 5 further illustrates that the deterministic enable signal 114 may alternate between a logic-high and logic-low value every fourth time slot, while the randomized enable signal 116 alternates between logic-high and logic-low in a random pattern. In other words, in the example of FIG. 5, the signal 114 also exhibits a monotonous (i.e., single-frequency) switching pattern, whereas the signal 116 exhibits a switching pattern that is random and more varied in frequency. Together, FIGS. 4 and 5 illustrate that in each time period, the clock signal 116 may have a different switching pattern. Or put differently, FIGS. 4 and 5 illustrate that the switching pattern of the randomized enable signal 116 may change across different time periods, while maintaining random characteristics in each period.

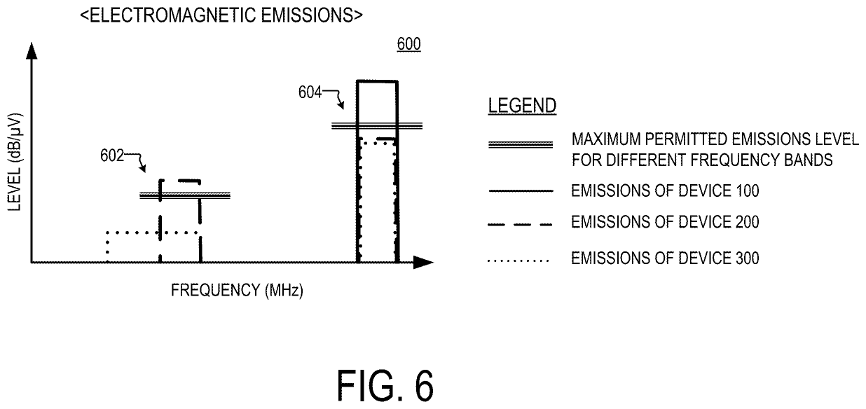

FIG. 6 is a plot 600 of the electromagnetic emissions of devices 100, 200, and 300. The plot shows peak clusters 602 and 604 that occur in two different frequency bands. Also shown in the plot are the maximum permitted emission levels for the two frequency bands. The plot 600 is provided only for the purpose of illustrating that using the circuit 302 could lead to a reduction of electromagnetic emissions in particular frequency bands, while spreading the same emissions over a broader range of frequencies. In this regard, it will be understood that the plot 600 is not intended to provide a realistic representation of the full range of emissions that would be produced by an electronic device under normal operating conditions.

Each of the peaks in cluster 604 corresponds to a different one of the devices 100-300. In cluster 604, the level of the peak corresponding to device 100 is attributable to both the DSP 106 and the ADC 104 being switched at the frequency of the clock signal 112. In cluster 604, the level of the peaks corresponding to devices 200 and 300 are attributable to only the ADC 104 in those devices being switched at the frequency of the clock signal 112, and this is why those peaks are substantially lower than the peak corresponding to device 100. In one respect, cluster 604 illustrates that the use of a randomized enable signal could help bring down, below a maximum limit, the emissions of a device in a particular band.

Each of the peaks in the cluster 602 corresponds to a different one of the devices 200-300. In cluster 602, the peak corresponding to device 200 is higher than the peak corresponding to device 300, and it has a narrower width than the peak corresponding to device 300. These differences are attributable to the DSP 106 in device 200 being operated by using a deterministic enable signal, while the DSP 106 in device 300 is operated by using with a randomized enable signal. In one respect, cluster 602 illustrates that the introduction of a randomized enable signal in a device may cause a spread of the electromagnetic emissions of the device across a wider frequency range, thereby lowering the emissions levels in individual frequencies. In other words, cluster 602 illustrates that the use of the circuit 302 in a device could help bring down further the emissions of the device to meet a particular emissions limit. As can be readily appreciated, cluster 602 illustrates that the circuit 302 may serve as a valuable tool for meeting various emission compliance standards.

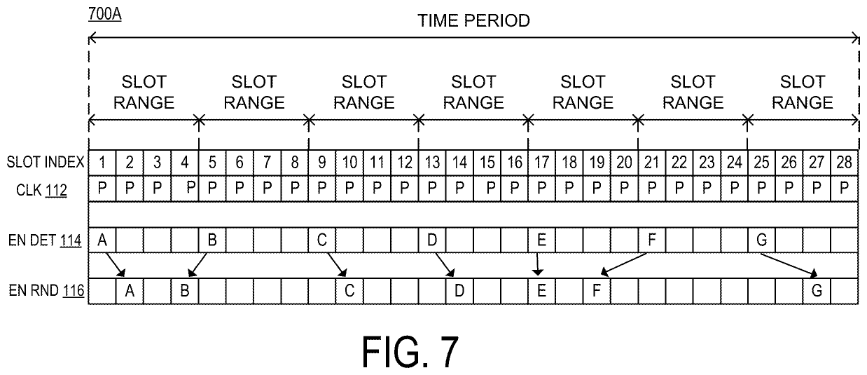

FIG. 7 is a chart illustrating another aspect of the operation of the randomized circuit 302. FIG. 7 illustrates that the method employed by the randomized circuit 302 results in a comparatively random distribution of the of the randomized enable signal 116 across a particular time period.

Shown in FIG. 7 is a table 700A that illustrates the distribution of peaks in each of the signals 112, 114, and 116 during different time slot ranges in the same time period. In table 700A, each of the time slots in the period is given a respective identifier that is unique for the time period. The presence of a letter in the column beneath each time slot identifier denotes the presence of a peak in a corresponding signal during that time slot, while the absence of a letter denotes the absence of a peak. The peaks in the clock signal 112 are labeled with the letter ‘P’. In this regard, table 700A illustrates that a peak in the clock signal 112 occurs in each of the time slots of the time period. The peaks in the divided clock signal 114 are labeled with the letters ‘A’, ‘B’, ‘C’, ‘D’, E′, ‘F’, and ‘G’. Table 700A illustrates that a peak in the divided clock signal 114 occurs every fourth time slot. The peaks in the divided clock signal randomized enable signal 116 are also labeled with the letters ‘A’, ‘B’, ‘C’, ‘D’, ‘E’, ‘F’, and ‘G’.

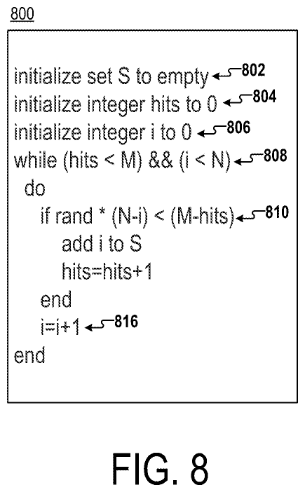

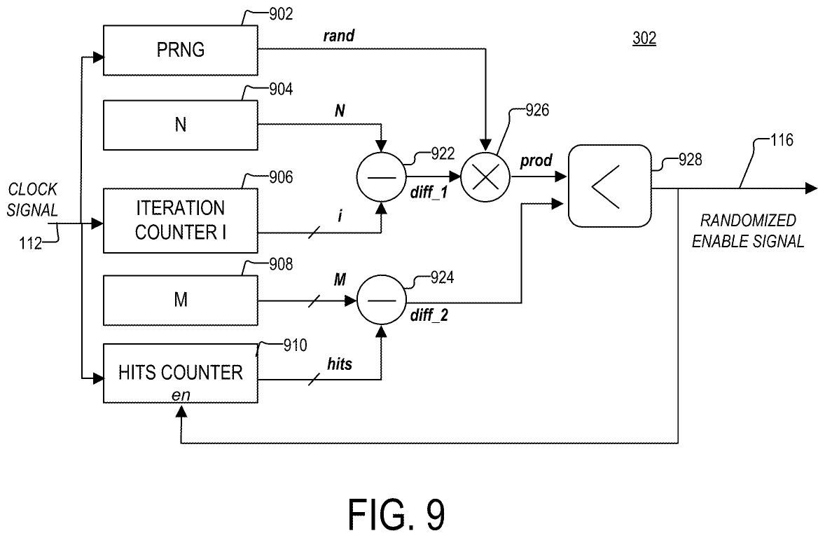

FIG. 8 shows an example of an algorithm 800 for generating the randomized enable signal 116. In some implementations, the algorithm 800 may be implemented in hardware, using electronic circuitry, such as the circuitry that is shown in either FIG. 9 or FIG. 11. Additionally or alternatively, in some implementations, the algorithm 800 may be implemented in software, or as a combination of hardware and software.

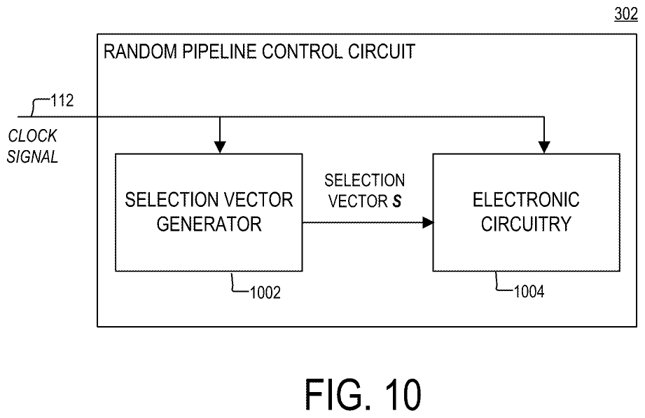

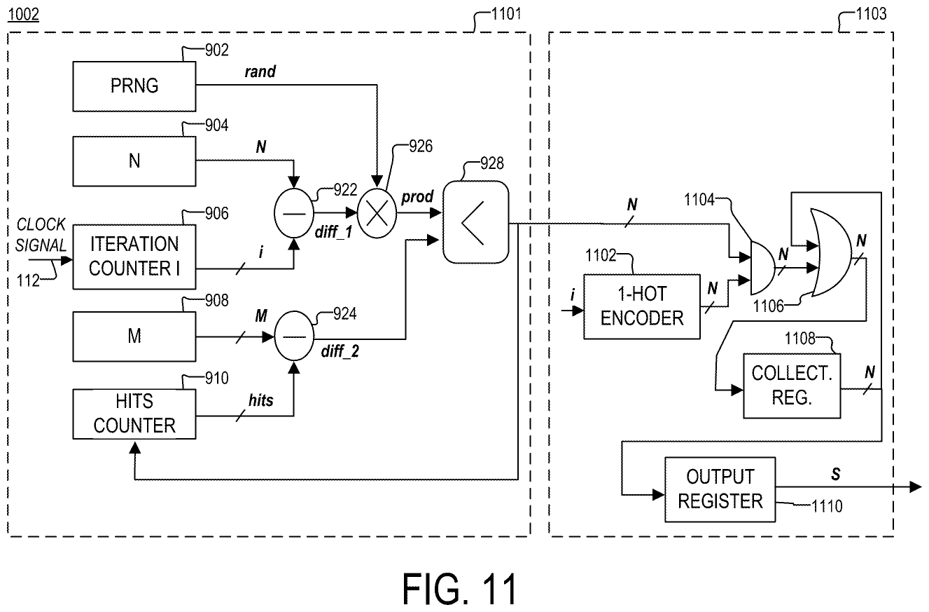

The output of the algorithm 800 is a selection vector S. Once complete, the selection vector S may identify all of the time slots in a time period that are scheduled to contain a peak of the signal 116—i.e., time slots in which the signal 116 should transition from logic-low to logic-high, and possibly back to logic low (e.g., time slots in which the signal should activate a block or a stage in the pipeline of the DSP block). The selection vector S may be provided to electronic circuitry that is configured to impart peaks on the randomized enable signal 116 in the time slots identified by the selection vector S. An example of such circuitry is the signal generator 1004, which is shown in FIG. 10. Although in the example of FIG. 8 the selection vector S identifies all peaks in the randomized enable signal 116 that are scheduled to occur during a given time period, in alternative implementations are possible in which the selection vector S identifies only peaks that are scheduled to occur within a particular time slot range and/or in another suitable time unit.

The algorithm 800 is now described in further detail. At line 802, the selection vector S is initialized. At line 804, counter hits is initialized. At line 806, a counter i is initialized. At line 808, a check is performed if hits is less than M and if i is less than N. Variable N specifies the number of time slots available within a period. Variable M specifies the number of peaks that are desired to occur in the randomized enable signal 116 during the time period. At line 810, a determination is made if the product of a random variable (that belongs to the range [0, 1[) and (N-i) is less than (M-hits). If the condition is true, the value of i is added to the selection vector S and the counter hits is incremented. The counter hits, in other words, indicates the count of time slots that have been so far selected to have a peak in the randomized enable signal 116. At line 816, the counter i is incremented.

In some implementations, the varying constraint that is specified in line 810 ensures that a desired number of time slots (i.e., M time slots) are picked every time the algorithm 800 is executed, and each of the time slots has an equal probability of being selected despite the fact that the selection pool from which time slots can be chosen shrinks with each subsequent iteration (of the while loop started in line 808). For instance, in the extreme case, when the remaining slots in the period are equal to the slots needed to fill the M slots, the algorithm guarantees that each of the remaining time slots would be selected.

As can be readily appreciated, the term (N-i) identifies the size of the selection pool from which time slots can be chosen, and the term (M-hits) identifies the number of time slots that remain to be selected in order for the desired number of time slots to be met. The rand function generates a random fixed-point binary number that is greater than or equal to 0 and less than 1. Multiplying the term (N-i) by the product of the rand function essentially introduces a random element into the condition of line 810. However, as the while loop (started in line 808) progresses, the condition of line 810 becomes more likely to evaluate to TRUE, which in turn enforces a relatively even distribution of the peaks in the random enable signal across the entire time period. Under the nomenclature of the present application, any number that is at least in part based on (N-i) may be referred to as a first count of time slots for which the condition specified by line 810 has not been evaluated yet because such number would be indicative, or at least proportional, to the first count. Under the nomenclature of the present disclosure, any number that is at least in part based on (M-hits) may be referred to as a second count of time slots that remain to be selected because such number would be indicative, or at least proportional, to the second count.

According to the present disclosure, it has been determined through simulation, that when the algorithm 800 is executed, each of the time slots in the period of N time slots has an equal probability of being selected, which causes the peaks of the randomized enable signal to be distributed relatively evenly (and with only limited variation) through the entire period of N time slots. The simulation involved executing the process more than 1000 times and counting how many times each of the time slots in the set of N time slots was selected over the entire set of executions.

FIG. 9 is a diagram of an example of the circuit 302, according to aspects of the disclosure. As illustrated, the circuit 302 may include a random number generator 902, a register 904, a counter 906, a register 908, a counter 910, a subtraction circuit 922, a subtraction circuit 924, a multiplication circuit 926, and a comparator 928. The random number generator 902 may be configured to generate a fixed-point binary random number rand. The register 904 may be configured to store a variable N. Variable N specifies the number of time slots that are available in a time period. The counter 906 may include electronic circuitry that is configured to increment a counter i and revert the counter i to an initial value once a predetermined (e.g., maximum) value (N-1) is reached by the counter i. Register 908 may be configured to store a variable M. Variable M specifies the number of peaks that are desired to occur in the randomized enable signal 116 during the time period defined by the variable N. In other words, M specifies the number of peaks in the randomized enable signal 116. The counter of 910 may include electronic circuitry that is configured to increment a counter hits and revert the counter hits to an initial value once the iteration counter 906 reaches a predetermined (e.g., maximum) value (N-1). The value of hits may be incremented every time the condition tested by the comparator 928 evaluates to TRUE, and the output of the comparator 928 is set to logic-high. The subtraction circuit 922 may be configured to calculate the difference diff_1 between N and i. The multiplication circuit 926 may be configured to calculate the product of diff_1 and rand. The subtraction circuit 924 may be configured to calculate the difference diff_2 between M and hits. The comparator 928 may be configured to compare prod to diff_2. If prod is less than diff_2, the comparator 928 may set the randomized enable signal 116 to logic-high and hold it at this level for one time slot.

The counter 906, the counter 910 and the PRNG 902 may be driven by the clock signal 112 (e.g., the value of i may be incremented on each rising edge of the clock signal 112, etc.) Although in the example of FIG. 9, the randomized enable signal 116 is output directly from the comparator 928, alternative implementations are possible in which the output of the comparator is used to drive other electronic circuitry, and the other electronic circuitry outputs the randomized enable signal 116. The other electronic circuitry may be configured to set a particular voltage level for the randomized enable signal 116 and/or impart a small delay on the randomized enable signal. In any event, the randomized enable signal 116 may have the same or similar waveform as the output of the comparator 928.

In some respects, FIG. 9 illustrates that the technique employed by the circuit 302 for generating the randomized enable signal 116 may be used to generate the randomized enable signal in-real time (or “on the fly”). This is in contrast with the example of FIG. 8, in which the randomized enable signal 116 is generated in a “deferred” fashion. In the example of FIG. 8, the pattern of the randomized enable signal 116 is calculated in a wholesale fashion for an entire time period, before the beginning of the time period, whereas in the example of FIG. 9, the value of the randomized enable signal 116 in each time slot may be determined immediately before the beginning of the time slot. Despite this distinction, it will be appreciated that, in the example of FIG. 9, the circuit 302 utilizes most of the algorithm 800, which is discussed above with respect to FIG. 8.

Generating the randomized enable signal 116 on the fly is advantageous because it requires fewer hardware pieces and it is simpler to implement than implementations in which the output of the randomized enable signal 116 is delayed by one period, such as the implementation shown in FIGS. 10-11. It is further notable that the circuit 302 is capable of spreading out the peaks in the randomized enable signal 116 in a random but yet relatively even pattern across the entire time period (of N time slots), all the while the circuit 302 is assigning a peak or a trough to each time slot in a forward fashion, one-at-a-time, and without full control of how the assignments of future time slots in the same period would play out. It will be understood that the implementation of the circuit 302, which is shown in 9, as well as the algorithm 800 shown in FIG. 8, do not guarantee a relatively even distribution of peaks in the signal 116. However, according to the present disclosure, it has been determined that the circuit 900 and/or algorithm 800 are more likely than to yield an even distribution of peaks across a time period (of N time slots). As noted above, the determination has been made through simulation.

FIG. 10 is a diagram of an example of the circuit 302, according to another implementation. As illustrated, the circuit 302 may include a selection vector generator 1002 and electronic circuitry 1004. The selection vector generator 1002 may include any suitable type of processing circuitry that is configured to generate a selection vector S. The selection vector S identifies a plurality of time slots in a time period in which the randomized enable signal 116 is required to have a peak—i.e., time slots in which the randomized enable signal 116 is required to transition from logic-low to logic-high and possibly back to logic-low. In some implementations, the selection vector generator 1002 may be configured to implement the algorithm 800, which is discussed above with respect to FIG. 8. Additionally, or alternatively, in some implementations, the selection vector generator 1002 may be implemented as discussed further below with respect to FIG. 11.

The electronic circuitry 1004 may include any suitable type of processing circuitry that is configured to receive the selection vector S and use the selection vector S to drive the performance of corresponding actions. If a bit in the selection vector S is set to ‘1’, this could mean that the electronic circuitry may perform an action. If the bit in the selection vector S is set to ‘0’, this could mean that the electronic circuitry 1004 is required to take another action or remain idle. At each rising edge of the clock signal 112, the electronic circuitry 1004 may retrieve a corresponding bit of the selection vector S and determine whether a particular action needs to be performed based on the value of the bit. As noted above, in some implementations, the electronic circuitry 1004 may generate a waveform that is the same or similar to the waveform of signal 116, which is shown in FIG. 4. However, it will be understood that the present disclosure is not limited to any specific way of using the selection vector S. Under the nomenclature of the present disclosure, the selection vector S is considered a type of randomized enable signal, and so is any other signal that is generated, at least in part, based on the selection vector S.

FIG. 11 is a diagram illustrating the selection vector generator 1002, according to one particular implementation. As illustrated, the selection vector generator 1002 may include a circuit 1101 and a circuit 1103. In the example of FIG. 11, the circuit 1101 is the same or similar to the circuit that is shown in FIG. 9. Furthermore, in the example of FIG. 11, the circuit 1103 may include a 1-hot encoder 1102, an AND gate 1104, an OR gate 1106, a collection register 1108, and an output register 1110. The 1-hot encoder 1102 may be configured to encode the value of i by using one-hot encoding. The comparator 928 may be configured to output a first value (e.g., ‘1’) when prod is less than diff_2, and a second value (e.g., ‘0’), when prod is greater than or equal to diff_2. The AND gate 1104 may be configured to pass through the value that is output from the 1-hot encoder 1102 (i.e., the one-hot encoded value of i) when prod is less than diff_2. The OR gate 1106 may be configured to add the value of i that is passed through the AND gate 1104 to the contents of the collection register 1108. Because i is encoded using 1-hot encoding, the logic-OR operation performed by the OR gate 1106 also works as an addition operation. After i has reached its maximum value, and when it is about to revert to an initial value such as ‘0’, the contents of the collection register 1108 may be latched into the output register 1110. The data that is stored in the output register 1110 constitutes the output vector S.

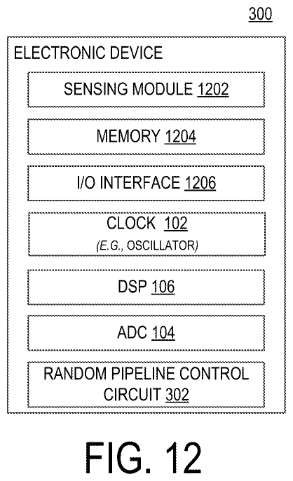

FIG. 12 shows device 300, according to one possible implementation. In the example of FIG. 12, device 300 is a sensor, and it includes a sensing module 1202, a memory 1204, and an I/O interface 1206, in addition to the DSP 106, the clock 102, the circuit 302, and the ADC 104. The sensing module 1202 may include one or more sensing elements, such as magnetic field sensing elements, an optical sensing element, a temperature sensing element, and/or any other suitable type of sensing element. The memory 1204 may include any suitable type of volatile or non-volatile memory, such as one or more of a flash memory, an Electrically Erasable Programmable Read-Only Memory (EEPROM), a Synchronous Dynamic Random-Access Memory (SDRAM), a solid-state drive (SSD), and/or any other suitable type of memory. The I/O interface 1206 may include one or more of an Ethernet interface, a Z-wave interface, a Zigbee interface, a CANBUS interface, an I2C interface, a Universal Serial Bus (USB) interface, and/or any other suitable type of interface. The DSP 106 may include any suitable type of processing circuitry, such as a general-purpose processor, an application-specific circuit, a signal processor, etc. Although in the example of FIG. 12 the clock 102 is depicted as being separate of the DSP 106, alternative implementations are possible in which the clock 102 is at least partially integrated into the DSP 106.

In the example of FIG. 12, the circuit 302 is configured to drive the DSP 106. However, alternative implementations are possible in which the circuit 302 is configured to drive one or more of the sensing module 1202, the memory 1204, and the I/O interface 1206 (in addition to or instead of the DSP 106). Stated succinctly, the present disclosure is not limited to the circuit 302 being used to drive any specific electronic component or set of electronic components. Although in the example of FIG. 12 device 300 is a digital sensor, alternative implementations are possible in which device 300 is any other suitable type of device that includes clock-driver circuitry, such as a laptop computer, a smartphone, a desktop computer, a system-on-a-chip, a signal processor, etc. In this regard, it will be understood that the present disclosure is not limited to the circuit 302 being used in any specific type of device.

Although in the example of FIGS. 3-12, the DSP 106 is enabled when the randomized enable signal is logic-high alternative implementations are possible in which the DSP 106 is enabled when the randomized enable signal is logic-low. In such implementations, the circuit 302 may be configured to determine troughs, rather than peaks. More particularly, in such implementations, the circuit 302 may be configured to identify time slots in which the randomized enable signal 116 should be logic-low. Furthermore, although in the examples provided throughout the disclosure the output of the circuit 302 is used as an enable signal, it will be understood that the present disclosure is not limited to any specific use of the output. For example, in some implementations, the output of the circuit 302 may be used as a clock signal, etc. As used herein, the phrase “feature of an enable signal” may refer to either a peak in the signal or a through in the signal. As used throughout the disclosure, the term “random” may also mean “pseudorandom” if permitted by context. The term “peak/hit” as used in the context of an enable signal refers to the enable signal being set to a logic-high value. The term “trough” as used in the context of an enable signal refers to the enable signal being set to a logic-low value.

Although in the example of FIGS. 3-12, the circuit 302 is used to generate an enable signal, it will be understood that the present disclosure is not limited to generating an enable signal, in particular, for as long as the signal generated signal has the same or similar waveform as the randomized enable signal from the example of FIGS. 3-12. In some implementations, the signals that is output from the circuit 302 may be used a clock signal and/or in any other suitable manner.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

To the extent directional terms are used in the specification and claims (e.g., upper, lower, parallel, perpendicular, etc.), these terms are merely intended to assist in describing and claiming the invention and are not intended to limit the claims in any way. Such terms, do not require exactness (e.g., exact perpendicularity or exact parallelism, etc.), but instead it is intended that normal tolerances and ranges apply. Similarly, unless explicitly stated otherwise, each numerical value and range should be interpreted as being approximate as if the word “about”, “substantially” or “approximately” preceded the value of the value or range.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative implementations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

While the exemplary embodiments have been described with respect to processes of circuits, including possible implementation as a single integrated circuit, a multi-chip module, a single card, or a multi-card circuit pack, the described embodiments are not so limited. As would be apparent to one skilled in the art, various functions of circuit elements may also be implemented as processing blocks in a software program. Such software may be employed in, for example, a digital signal processor, micro-controller, or general-purpose computer.

Some embodiments might be implemented in the form of methods and apparatuses for practicing those methods. Described embodiments might also be implemented in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the claimed invention. Described embodiments might also be implemented in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the claimed invention. When implemented on a general-purpose processor, the program code segments combine with the processor to provide a unique device that operates analogously to specific logic circuits. Described embodiments might also be implemented in the form of a bitstream or other sequence of signal values electrically or optically transmitted through a medium, stored magnetic-field variations in a magnetic recording medium, etc., generated using a method and/or an apparatus of the claimed invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments.

Also, for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

It will be further understood that various changes in the details, materials, and arrangements of the parts which have been described and illustrated in order to explain the nature of the claimed invention might be made by those skilled in the art without departing from the scope of the following claims.

1. A system comprising:
a clock configured to generate a clock signal, the clock signal being arranged to have N type-1 features in a given time period, each of the N type-1 features of the clock signal being generated in a different one of a plurality of time slots of the given time period;
a signal generator configured to generate a randomized signal based on the clock signal, the randomized signal being generated by selecting M time slots from the plurality of time slots and transitioning the randomized signal from a first value to a second value in each of the selected M time slots,
wherein M and N are positive integers and M<N, and
wherein selecting the M time slots includes evaluating a respective randomized condition for each of the plurality of time slots and selecting the time slot when the randomized condition holds true, the randomized condition being based on a comparison between a count of remaining ones of the plurality of time slots for which the randomized condition has not been evaluated yet and a count of time slots that remain to be selected.

2. The system of claim 1, wherein:
the signal generator includes a selection unit and a signal generator,
the selection unit is configured to generate a selection vector that identifies each of the selected M time slots, and
the signal generator is configured to generate the randomized signal based on the selection vector.

3. The system of claim 1, wherein the randomized signal includes a randomized enable signal and the signal generator includes an enable signal generator.

4. The system of claim 1, further comprising:
a first electronic component that is driven with the clock signal; and
a second electronic component that is driven with the randomized signal.

5. The system of claim 1, wherein evaluating the respective randomized condition for each of the plurality of time slots and selecting the time slot when the randomized condition holds true includes:
generating a random number between 0 and 1;
calculating a first difference between N and an iteration counter;
calculating a second difference between M and a hits counter;
detecting whether a product of the random number and the first difference is less than the second difference;
when the product is less than the second difference: (i) selecting one of the plurality of time slots that has a same index as the iteration counter and (ii) incrementing the hits counter, and
when the product is not less than the second difference: (i) refraining from selecting a time slot and (ii) refraining from incrementing the hits counter.

6. The system of claim 5, wherein selecting one of the plurality of time slots that has a same index as the iteration counter includes encoding the iteration counter by using 1-hot encoding and adding the encoded iteration counter to a selection vector.

7. The system of claim 1, wherein:
generating the randomized signal further includes transitioning the randomized signal back to the first value,
the clock signal includes a plurality of type-2 features,
each of the type-1 features of the clock signal is a peak, and
each of the type-2 features of the clock signal is a through.

8. A method, comprising:
generating a clock signal, the clock signal being arranged to have N type-1 features in a given time period, each of the N type-1 features of the clock signal being generated in a different one of a plurality of time slots of the given time period;
generating a randomized signal based on the clock signal, the randomized signal being generated by selecting M time slots from the plurality of time slots and transitioning the divided randomized signal from a first value to a second value in each of the selected M time slots,
wherein M and N are positive integers and M<N, and
wherein selecting the M time slots includes evaluating a respective randomized condition for each of the plurality of time slots and selecting the time slot when the randomized condition holds true, the randomized condition being based on a comparison between a count of remaining ones of the plurality of time slots for which the randomized condition has not been evaluated yet and a count of time slots that remain to be selected.

9. The method of claim 8, wherein:
the randomized signal is generated by a signal generator;
the signal generator includes a selection unit and a signal generator;
the selection unit is configured to generate a selection vector that identifies each of the selected M time slots, and
the signal generator is configured to generate the randomized signal based on the selection vector.

10. The method of claim 8, wherein the M time slots are selected in a pseudo-random fashion.

11. The method of claim 8, further comprising operating an electronic component with both the clock signal and the randomized signal.

12. The method of claim 8, wherein evaluating the respective randomized condition for each of the plurality of time slots and selecting the time slot when the randomized condition holds true includes:
generating a random number between 0 and 1;
calculating a first difference between N and an iteration counter;
calculating a second difference between M and a hits counter;
detecting whether a product of the random number and the first difference is less than the second difference;
when the product is less than the second difference: (i) selecting one of the plurality of time slots that has a same index as the iteration counter and (ii) incrementing the hits counter, and
when the product is not less than the second difference: (i) refraining from selecting a time slot and (ii) refraining from incrementing the hits counter.

13. The method of claim 12, wherein selecting one of the plurality of time slots that has a same index as the iteration counter includes encoding the iteration counter by using 1-hot encoding and adding the encoded iteration counter to a selection vector.

14. The method of claim 8, wherein:
the signal generator is further configured to transition the randomized enable signal back to the first value in each of the M time slots, unless a next consecutive time slot is also selected,
the randomized enable signal includes a plurality of type-2 features,
each of the type-1 features of the clock signal is a peak, and
each of the type-2 features of the clock signal is a through.

15. An enable signal generator, comprising:
a selection circuitry configured to: (i) receive a clock signal that is arranged to have N type-1 features in a given time period, each of the N type-1 features of the clock signal being generated in a different one of a plurality of time slots of the given time period, and (ii) generate a selection vector based on the clock signal, the selection vector being arranged to identify M time slots that are selected from the plurality of time slots, where M and N are positive integers and 1≤M<N; and
a signal generator configured to: (i) receive the selection vector from the selection circuitry and (ii) generate a randomized enable signal based on the selection vector, the randomized enable signal being generated by transitioning the randomized enable signal from a first value to a second value in each of the selected M time slots that are identified in the selection vector,
wherein the M time slots are selected at random.

16. The clock enable signal generator of claim 15, wherein the M time slots are selected in a pseudo-random fashion.

17. The enable signal generator of claim 16, wherein the M time slots are selected by using selection logic that guarantees that any of the time slots in the plurality has a substantially same probability of being selected as any other one of the time slots in the plurality.

18. The enable signal generator of claim 15, wherein generating the randomized enable signal includes:
generating a random number between 0 and 1;
calculating a first difference between N and an iteration counter;
calculating a second difference between M and a hits counter;
detecting whether a condition is satisfied, the condition being based on whether a product of the random number and the first difference is less than the second difference;
when the condition is satisfied: (i) selecting one of the plurality of time slots that has a same index as the iteration counter and (ii) incrementing the hits counter, and
when the condition is not satisfied: (i) refraining from selecting a time slot and (ii) refraining from incrementing the hits counter.

19. The enable signal generator of claim 18, wherein:
the selection vector is encoded by using 1-hot encoding, and
selecting one of the plurality of time slots that has a same index as the iteration counter includes: (i) encoding the iteration counter by using 1-hot encoding and (ii) adding the encoded iteration counter to the selection vector.

20. The enable signal generator of claim 15, wherein:
the signal generator is further configured to transition the randomized enable signal back to the first value in each of the M time slots, unless a next consecutive time slot is also selected,
the randomized enable signal includes a plurality of type-2 features,
each of the type-1 features of the clock signal is a peak, and
each of the plurality of type-2 features of the clock signal is a through.

21. A method, comprising:
receiving a clock signal that is arranged to have N type-1 features in a given time period, each of the N type-1 features of the clock signal being generated in a different one of a plurality of time slots of the given time period;
generating a selection vector based on the clock signal, the selection vector being arranged to identify M time slots that are selected from the plurality of time slots, where M and N are positive integers and 1<M<N; and
generating a randomized enable signal based on the selection vector, the randomized enable signal being generated by setting the randomized enable signal to a second value in each of the selected M time slots that are identified in the selection vector,
wherein the M time slots are selected at random.

22. The method of claim 21, wherein the M time slots are selected in a pseudo-random fashion.

23. The method of claim 22, wherein the M time slots are selected by using selection logic that guarantees that any of the time slots in the plurality has a substantially same probability of being selected as any other one of the time slots in the plurality.

24. The method of claim 21, wherein generating the randomized enable signal includes:
generating a random number between 0 and 1;
calculating a first difference between N and an iteration counter;
calculating a second difference between M and a hits counter;
detecting whether a condition is satisfied, the condition being based on whether a product of the random number and the first difference is less than the second difference;
when the condition is satisfied: (i) selecting one of the plurality of time slots that has a same index as the iteration counter and (ii) incrementing the hits counter, and
when the condition is not satisfied: (i) refraining from selecting a time slot and (ii) refraining from incrementing the hits counter.

25. The method of claim 24, wherein:
the selection vector is encoded by using 1-hot encoding, and
selecting one of the plurality of time slots that has a same index as the iteration counter includes: (i) encoding the iteration counter by using 1-hot encoding and (ii) adding the encoded iteration counter to the selection vector.

26. The method of claim 21, wherein:
the signal generator is further configured to transition the randomized enable signal back to the first value in each of the M time slots,
the randomized enable signal includes a plurality of type-2 features,
each of the type-1 features of the clock signal is a peak, and
each of the type-2 features of the clock signal is a through.

27. A system, comprising:
means for generating a clock signal, the clock signal being arranged to have N type-1 features in a given time period, each of the N type-1 features of the clock signal being generated in a different one of a plurality of time slots of the given time period;
means for generating a randomized signal based on the clock signal, the randomized signal being generated by selecting M time slots from the plurality of time slots and setting the randomized signal to a second (active) value in each of the selected M time slots,
wherein M and N are positive integers and M<N,
wherein each of the plurality of time slots is equally likely to be selected.
